(19) United States
(12) Patent Application Publication
(10) Pub. No.: US 2007/0098959 A1
(43) Pub. Date: May 3, 2007

(54) SUBSTRATES AND ARTICLES HAVING SELECTIVE PRINTED SURFACE RELIEFS

(76) Inventor: Daniel Lieberman, San Diego, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/551,205

(22) Filed: Oct. 19, 2006

Related U.S. Application Data
(63) Continuation-in-part of application No. 11/198,625, filed on Aug. 5, 2005.
Application No. 11/198,625 is a continuation-in-part of application No. 11/144,349, filed on Jun. 3, 2005.

(51) Int. Cl. B32B 3/00

(52) U.S. Cl. 428/172

(57) ABSTRACT

The present invention provides articles comprising a substrate, a coating that is applied to the substrate, and surface reliefs that are cast or embossed onto the coating at substantially the same speeds and widths of conventional printing, and in substantially perfect register to conventional printing, wherein the coating is selected from the group consisting of HRISR coatings, LRISR coatings, water-based coatings, solvent-based coatings, UV/EB based coatings, sol-gel based coatings, conductive coatings, silver reduction based coatings and metallic coatings. A protective or printed layer may (or may not) be applied on top of the coating. Specifically, if the coating is an HRISR or LRISR coating, then it is unnecessary to apply a special high refractive layer because HRISR and LRISR coatings inherently contain the refractive index properties that are necessary to keep the surface reliefs viewable despite any printing on top of the coating. Otherwise, if the coating does not comprise an HRISR or LRISR coating, then a high refractive protective layer is applied on top of the coating, wherein the protective layer follows a topography of the surface reliefs such that a thickness of the protective coating is substantially uniform.

### REFERENCE TO RELATED APPLICATIONS

This application is a Continuation-In-Part of U.S. patent application Ser. No. 11/198,625, filed Aug. 5, 2005, which is a Continuation-In-Part of U.S. patent application Ser. No. 11/144,349, filed Jun. 3, 2005, the contents of which is incorporated herein by reference in its entirety.

### FIELD OF THE INVENTION

The present invention is directed to surface reliefs, and more particularly to, substrates and articles having selective printed surface reliefs that are applied using conventional printing equipment.

### BACKGROUND OF THE INVENTION

Conventional holographic surface reliefs are manufactured by slow embossing and casting processes that are separate from mainstream printing processes. For example, the processes may involve embossing onto pre-metallized materials or casting onto clear films and papers, and then metallizing the embossed materials. These embossing and casting processes suffer from a number of known drawbacks, including: (1) the processes are not suitable for use with the printing equipment; (2) embossing or casting in localized regions is not possible with conventional metallizing equipment; (3) the metallizing equipment is prohibitively expensive; (4) printing onto the embossed and metallized material is very slow and expensive; (5) conventional embossing and casting systems are much slower than printing equipment; (6) it is difficult to overprint onto a holographic substrate when perfect registration is required; (7) holographic substrates may cover the entire face of the substrate, which may be a problem if the final product is a label, package or security document; and (8) holographic hot-stamping and cold-stamping substrates may have to be added to the printing in attachments placed on the conventional printing equipment.

### SUMMARY OF THE INVENTION

In view of the foregoing, it is an object of the present invention to provide substrates and articles having selectively printed surface reliefs that are applied using conventional printing equipment.

It is another object of the invention to provide substrates and articles (such as currency, flexible and rigid packaging, labels, and printed forms) having selective printed surface reliefs that are applied using conventional printing equipment.

It is a further object of the invention to provide substrates and articles having printing surface reliefs that are applied at the same speeds as conventional printing processes and in substantially perfect registration to conventional printing using the same printing equipment.

The present invention is directed to substrates and articles having selective printed surface reliefs that are applied using conventional printing equipment. For example, the articles may comprise labels, flexible and rigid packaging, continuous forms, government documents, currency, plastic bottles, plastic containers, ceramics, and other substrates and articles. In operation, the surface reliefs are selectively printed or printed as a continuous pattern, preferably using conventional printing processes such as intaglio, flexography, rotogravure, offset printing, litho; ink jet or digital printing. The surface reliefs may be created with high refractive index inks such as metallic inks, transparent inks, semi-transparent inks, security inks, color shifting inks, luminescent inks, phosphorescent inks, thermochromatic inks, invisible inks, scratch off inks, pearlescent inks, dielectric inks, silver inks, conductive inks and combinations thereof. These inks may be UV/EB based, solvent based, water based or silver reduction based.

One aspect of the present invention involves an article comprising a substrate, a coating that is applied to the substrate, and surface reliefs that are cast or embossed onto the coating at substantially the same speeds and widths of conventional printing, and in substantially perfect register to conventional printing, wherein the coating is selected from the group consisting of HRISR coatings, LRISR coatings, water-based coatings, solvent-based coatings, UV/EB based coatings, sol-gel based coatings, conductive coatings, silver reduction based coatings and metallic coatings. A protective or printed layer may (or may not) be applied on top of the coating. Specifically, if the coating is an HRISR or LRISR coating, then it is unnecessary to apply a special high refractive layer because HRISR and LRISR coatings inherently contain the refractive index properties that are necessary to keep the surface reliefs viewable despite any printing on top of the coating. Otherwise, if the coating does not comprise an HRISR or LRISR coating, then a high refractive protective layer is applied on top of the coating, wherein the protective layer follows a topography of the surface reliefs such that a thickness of the protective coating is substantially uniform. The article may comprise an item including without limitation: (1) a tattoo; (2) a shrink wrap label; (3) flexible packaging; (4) rigid packaging; (5) a credit card; (6) a license; (7) a security document; (8) a retroreflective structure; (9) a non-reflective structure; (10) a self cleaning substrate; (11) a radio frequency identification product; (12) a plastic chip; (13) a micro-analysis system; (14) an optical component; (15) a medical application; (16) a polymer display; (17) a solar panel; (18) a defense application; or (19) a radar invisibility application.

In accordance with the principles of the invention, the surface reliefs may include, but are not limited to: holograms; optical variable devices; gratings; computer generated holograms; ebeam generated structures; dot matrix holograms; dot matrix stereograms; retroreflective structures (e.g., corner cubes); nanostructures; microstructures; micro fluidic structures; micro electronic circuits; moire patterns; radio frequency identification (RFID) antennas; lenticular lenses; lenses; self cleaning structures; moth-eye structures; and combinations of these structures. According to some embodiments of the invention, a high or low refractive index lacquer or sol-gel is used to cast or emboss the surface reliefs on top of the substrate. According to additional embodiments, the article may further comprise a protective coating applied on top of the surface reliefs, the transparent coating comprising a transparent ink, adhesive or laminate that conforms to the topography of the surface reliefs such that a thickness of the protective coating is substantially uniform.

Another aspect of the present invention involves an article comprising a substrate, a V or EB coating applied on top of the substrate, a high or low refractive index lacquer or sol-gel applied on top of the coating, surface reliefs created by the WV or EB coating, and surface reliefs created by the high or low refractive index lacquer or sol-gel. According to the invention, the lacquer or sol-gel may be water-based, UV/EB, solvent based, or silver reduction based. In some embodiments, the high or low refractive index lacquer or sol-gel is used to cast or emboss the surface reliefs on top of the substrate. During printing, the surface reliefs are applied to the substrate at substantially the same speeds and widths of conventional printing, and in substantially perfect register to conventional printing. The article may further comprise a transparent protective coating applied on top of the surface reliefs, the coating comprising a transparent ink, adhesive or laminate that conforms to the topography of the surface reliefs such that a thickness of the protective coating is substantially uniform.

Other features and advantages of the present invention should become apparent from the following description of the preferred embodiments, taken in conjunction with the accompanying drawings, which illustrate, by way of example, the principles of the invention.

### BRIEF DESCRIPTION OF THE DRAWINGS

Embodiments of the present invention will now be described, by way of example only, with reference to the following drawings, in which:

FIG. 1A illustrates a coating of the present invention containing metallic particles;

FIG. 1B illustrates a coating of the present invention containing high (or low) refractive index particles;

FIG. 1C illustrates a coating of the present invention containing both metallic particles and high (or low) refractive index particles;

FIG. 2A illustrates a transparent coating of the present invention;

FIG. 2B illustrates a high (or low) refractive index surface relief coating of the present invention;

FIG. 2C illustrates a high (or low) refractive index surface relief plus metallic coating of the present invention;

FIG. 3A illustrates a transparent coating provided with an additional coating according to the principles of the present invention;

FIG. 3B illustrates a high (or low) refractive index surface relief coating provided with an additional coating according to the principles of the present invention;

FIG. 3C illustrates a high (or low) refractive index surface relief plus metallic coating that is provided with an additional coating according to the principles of the present invention;

FIG. 4A illustrates a high (or low) refractive index surface relief coating that is ith dielectric particles in accordance with the principles of the present invention;

FIG. 4B illustrates a retroreflective coating of the present invention;

FIG. 4C illustrates an EFD antenna hologram of the present invention;

FIGS. 5-12 depict various alternative articles of the present invention;

FIG. 13 illustrates the use of conventional printing equipment to print both onal ink based images and surface reliefs onto a substrate;

FIG. 14 depicts a system of printing surface reliefs on a substrate using onal printing equipment, in accordance with the principles of the present invention;

FIGS. 15A-15C are perspective views illustrating the substrate after a metallic er coated with a high refractive index material layer having surface reliefs is applied

FIG. 16 depicts a system of printing mirrored surface reliefs on a substrate using onal printing equipment;

FIG. 17 depicts an article produced in accordance with the principles of the invention;

FIG. 18 depicts another article produced in accordance with the principles of the invention.

FIG. 19 depicts a further article produced in accordance with the principles of the invention;

FIG. 20 depicts an additional article produced in accordance with the principles of ent invention;

FIG. 21 illustrates a currency document produced in accordance with the es of the present invention;

FIG. 22 illustrates a continuous label produced in accordance with the principles esent invention;

FIG. 23 illustrates a label produced in accordance with the principles of the present invention; and

FIG. 24 illustrates a container produced in accordance with the principles of the present invention.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention is directed to articles that incorporate micro and nano surface reliefs such as holograms, optically variable devices, diffractions gratings, nano optical color structures, biological and animal structures, and structures that exhibit surface reliefs between about 10 nm to about 3 mm. The surface relief structures are also referred to herein as “surface reliefs”. The articles of the invention may feature coatings (such as high refractive index surface relief (HRISR) coatings, low refractive index surface relief (LRISR) coatings, metallic inks and or lacquers, sol-gel coatings, silver reduction coatings, metallic inks, conductive inks or silver inks) for surface reliefs that are “printed” or cast (cured) using conventional or digital printing equipment with perfect registration to the conventional printing stations to produce surface relief structures such as holograms.

In accordance with the principles of the invention, the surface reliefs are printed on an article or substrate. For example, the surface reliefs may be applied using conventional printing processes such as flexography, intaglio, rotogravure, ink jet printing, digital printing, tampography and other printing processes. According to further embodiments of the invention, the surface reliefs may be applied to various substrates and articles using laser engraving techniques with or without a metal backing or injection molding techniques for producing high refractive index plastics. The surface reliefs described herein may be applied to any suitable article or substrate, either selectively or in a continuous pattern. When the surface reliefs are selectively applied, a portion of the article or substrate does not contain any surface reliefs. In many cases, the area on the substrate or article that contains surface reliefs is much smaller than the corresponding area that is devoid of surface reliefs, thereby providing a significant reduction in manufacturing cost.

The surface reliefs of the present invention may be created in a single step at a single station by applying a metallic ink or foil on top of a substrate, and then applying a transparent UV curable high refractive index (HRISR) ink, lacquer or sol-gel coating on top of the metallic ink or foil layer. Alternatively, the surface reliefs may be created by first applying any suitable ink and/or lacquer or sol-gel coating to an article or substrate, and then applying a HRISR ink and/or lacquer or sol-gel coating in register to the surface reliefs. As a further alternative, a single ink such as a UV curable metallic ink may be used to create both the surface reliefs and the high refractive properties needed for a specific application.

According to further embodiments of the invention, the surface reliefs may be created in two steps at two separate stations. By way of example, in a first step, a transparent high refractive index lacquer (no holography) is applied to a substrate at a first station, whereas in a second step, surface reliefs are embossed onto the high refractive index lacquer using pressure and heat. The resulting hologram is both highly refractive and transparent. Alternatively, a metallic ink (or stamping foil, silver ink, conductive ink, W based ink, solvent based ink, etc.) is applied to a substrate at a first station in a first step, while in a second step at a second station, the metallic ink is embossed. in this example, a high refractive index ink is not necessary because the ink is metallic. According to a further embodiment, in a first step at a first station, any UV curable lacquer is applied to a substrate to create holography. If a normal coating is applied, the holography would disappear because the coating is not highly refractive. in a second step at a second station, a high refractive index sol-gel or lacquer is applied on top of the UV curable ink, wherein the high refractive index sol-gel or lacquer follows the topography of the holography.

Additional embodiments of the invention may involve a silver reduction reaction, whereby predetermined chemicals are mixed to cause the silver reduction reaction. For example, a transparent UV curable lacquer is employed to create the surface reliefs, which are then exposed to a catalyst such as UV radiation. The exposure to Uv radiation having a predetermined wavelength (different than the wavelength of the UW radiation used to cure the transparent UV curable lacquer) causes the silver reduction reaction and makes the surface reliefs highly reflective. If not exposed to the U radiation, the surface reliefs remain transparent.

According to the invention, the surface reliefs may comprise inks possessing high and low refractive properties plus a wide variety of other effects including, but not limited to: (1) color shifting effects; (2) thermochromatic effects; (3) dielectric effects; (4) luminescent effects; (5) phosphorescent effects; (6) conductive effects; (7) metallic effects; and (8) combinations thereof. Additionally, the surface reliefs may be printed with any suitable ink and/or lacquer, and then covered with a registered HRISR ink and/or lacquer to provide the desired effects (e.g., color shifting, thermochromatic, etc.). According to further embodiments of the invention, surface reliefs are printed using conventional inks, wherein the entire substrate is flooded with a high and/or low refractive index ink and or lacquer to provide the desired effects (e.g., color shifting, thermochromatic, etc.).

The above-described surface reliefs may be printed in different shades or grades. In addition, the surface reliefs may be printed in register on top of already applied inks and/or lacquers, or may be overprinted with any suitable inks and/or lacquers in register or in a wallpaper pattern. These inks and lacquers obviate the need for already-embossed substrates including films, hot-starnping foils and cold-stamping foils. Such already-embossed substrates are expensive and difficult to integrate with conventional printing at high speeds and proper registration. Moreover, any of the surface reliefs described herein may be created by reverse printing a metallic ink and/or lacquer in order to give the resulting product a metallic look.

Applications for the surface reliefs of the present invention include, but are not limited to: (1) tattoos; (2) labels; (3) shrink wrap labels; (4) flexible packaging; (5) rigid packaging; (6) containers; (7) bottles; (8) credit cards; (9) licenses; (10) currency; (11) security documents such as continuous forms; (12) retrorefective structures; (13) non-reflective structures; (14) online lenticularprinting; (15) intelligent substrates such as self cleaning substrates; (16) radio frequency identification products; (17) plastic chips; (18) micro-analysis systems; (19) optical components; (20) medical applications; (21) polymer displays; (22) solar panels; (23) defense applications; and (24) radar invisibility applications.

The printed articles and substrates may include continuous wallpaper or may include selective areas with surface reliefs and/or lenticular images. In addition, the printed articles and substrates may include selective areas with non-shifting color structures or deep structures, such as Aztec holograms, that are either synthetically made or copied from biological and animal structures, such as by scanning or casting processes.

The coatings of the present invention may have a high refractive index, a low refractive index and/or metallic particles, as well as a good release from the embossing and/or casting tools used to produce the surface reliefs. Additionally, the coatings may be water-based, UV/EB, solvent based, or silver reduction based. In order to keep the holography viewable on the substrate, it is important that the HRISR and/or LRISR coatings have a different refractive index from any adhesives, laminates inks and/or lacquers that are applied to the surface relief. The holography is viewable even if the difference in refractive index is quite small.

The present invention provides nano-, micro- and macrostructures that exhibit surface reliefs of more than 5 nanometers to less than 3 millimeters in depth and width are “printed” or cast (cured) in conventional or digital printing equipment with perfect registration to the other printing stations. Such structures may be optical or non-optical in nature. For example, holograms may be printed such that they become reflective, semi-reflective or non-reflective in just one pass through the “printing” station. Some of the advancements described herein are due in part to recent developments in metallic ink technology, gearless technology, sleeve technology, electron beam technology, UV technology, and temperature control technology.

In accordance with the principles of the present invention, a selected HRISR or LJRISR coating may contain particulate matter such as metallic particles and/or high refractive index particles to make the coating highly reflective. Suitable particulate matter for producing reflective surface reliefs include, but are not limited to: (1) aluminum particles; (2) silver particles; (3) gold particles; (4) cobalt particles; (5) chromium particles; (6) platinum particles; (7) palladium particles; (8) nickel particles; (9) cobalt particles; (10) carbon particles; (11) platelets; (12) flakes; (13) dielectric particles; (14) cholesteric liquid crystal polymer particles; (15) magnetic pigment flakes; (16) holographic glitter particles; (17) aluminum oxides (e.g., AL2O3); (18) Ce2O3; (19) SnO2; (20) B2; (21) O3; (22) titanium dioxide (TIO2); (23) iron oxides (e.g., Fe3O4 and Fe2O3); (24) zirconium oxide (ZrO2); (25) zinc oxide (ZnO); (26) zinc sulfide (ZnS); (27) bismuth oxychloride; (28) indium oxide (In2O3); (29) indium-tin-oxide (ITO); (30) tantalum pentoxide (Ta2O5); (31) cenic oxide (CeO2); (32) yttrium oxide (Y2O3); (33) europium oxide (Eu2O3); (34) hafnium nitride (HfN); (35) hafnium carbide (HfC); (36) hafnium oxide (HfO2); (37) lanthanum oxide (La2O3); (38) magnesium oxide (MgO); (39) neodymium oxide (Nd2O3); (40) praseodymium oxide (Pr6O11); (41) samarium oxide (Sm2O3); (42) antimony trioxide (Sb2O3); (43) silicon carbide (SiC; (44) silicon nitride (Si3N4); (45) silicon monoxide (SiO); (46) selenium trioxide (Se2O3); (47) tin oxide (SnO2); (48) tungsten trioxide (WO3); and (49) combinations thereof.

According to further embodiments of the invention, a selected HRISR or LRISR coating may contain particulate matter adapted to create semi-transparent and metallizing effects. Suitable particulate matter for maintaining the transparency of the coating while keeping surface relief reflective enough in order to be easily seen (even when covered by adhesives, inks, lacquers, and/or laminates) include, but are not limited to: (1) titanium dioxide (TiO2); (2) iron oxide Fe2O3; (3) aluminum oxide (Al2O3); (4) Ce2O3; (5) tin oxide (SnO2); (6) boric oxide (B2O3); (7) titanium dioxide (TiO2); (8) zirconium; (9) zinc oxide (ZnO); (10) zinc sulfide (ZnS); (11) bismuth oxychloride; (12) Sb2O5; (13) zirconium oxide (ZrO2); (14) dielectric particles; (15) tungsten oxide (SnWO4); (16) oxide of bismuth (BiOx); (17) bismuth oxide (Bi2O3); (18) titanium oxide (TiO); (19) niobium oxide (Nb2O5); (20) carbon; (21) indium oxide (Jn2O3); (22) indium-tin-oxide (ITO); (23) tantalum pentoxide (Ta2O5); (24) ceric oxide (CeO2); (25) yttrium oxide (Y2O3); (26) europium oxide (Eu2O3); (27) Fe3O4; (28) hafnium nitride (HN); (29) hafnium carbide (HfC); (30) hafnium oxide (HfO2); (31) lanthanum oxide (La2O3); (32) magnesium oxide (MgO); (33) neodymium oxide (Nd2O3); (34) preododymium oxide (Pr6O11); (35) samarium oxide (Sm2O3); (36) antimony trioxide (Sb2O3); (37) silicon carbide (SiC; (38) silicon nitride (Si3N4); (39) silicon monoxide (SiO); (40) selenium trioxide (Se2O3); (41) tungsten trioxide (WO3); and (42) combinations thereof.

The HRISR and LRISR coatings described herein may also include particulate matter for achieving high transparency. Suitable particulate matter for LRISR coatings for producing the desired high transparency include, but are not limited to: (1) silicon dioxide (SiO2); (2) aluminum oxide AL2O3; (3) magnesium fluoride (MgF2); (4) aluminum fluoride (AlF3); (5) cerium fluoride (CeF3); (6) lanthanum fluoride (LaF3); (7) sodium aluminum fluorides (e.g., Na3AlF6 and Na3Al3Fl4); (8) neodymium fluoride (dF3); (9) samarium fluoride (SmF3); (10) barium fluoride (BaF2); (11) calcium fluoride (CaF2); (12) lithium fluoride (LiF); (13) monomers; (14) polymers; (15) dienes; (16) alkenes; (17) acrylates; (18) perfluoroalkenes; (19) polytetrafluoroethylene; (20) fluorinated ethylene propylene (FEP); and (21) combinations thereof.

In accordance with the invention, surface reliefs such as holograms are cast or embossed onto an HRISR or LRISR coating in a single pass, or in multiple passes. The surface reliefs may be metallized, semi-metallized or made transparent without the need for prohibitively expensive vacuum-metallizing or sputtering-metallizing equipment. Additionally, the coatings may be selected to possess optical coating properties such as magnetic properties, metallic properties and the ability to change colors. Moreover, the surface reliefs of the invention may be configured to interact with the HRISR and LRISR coatings to create innovative and improved optical effects.

In accordance with an aspect of the present invention, the HRISR and LRISR coatings allow a printer to print surface reliefs such as holography online and in register with conventional printing. Specifically, the coatings of the invention may be applied to an article or substrate using conventional printing equipment including, but not limited to: (1) offset printing; (2) flexographic printing; (3) rotogravure printing; (4) ink jet printing; (5) letterpress printing; (6) digital printing; (7) silk-screen printing; (8) intaglio printing; and (10) litho printing. The surface reliefs may also be produced using laser engraving processes with or without a metal backing material or injection molding processes for producing high refractive index plastics. The HRISR or LRISR coatings preferably are applied and embossed with a surface relief at the same color station. Alternatively, the HRISR or LRISR coatings may be applied in a co responding color station in register to a surface relief that was previously placed at a different color station.

The coatings of the present invention allow for the embossing and or casting of myriad surface reliefs online with any of the above-identified conventional printing equipment in substantially perfect register or without register to the printing of other conventional inks and/or lacquers. When HRISR or LRISR coatings are employed, these coatings already possess the desired visual properties (e.g., reflective, metallic, transparent, dielectric, etc.), such there is no need to coat the surface reliefs with additional coatings such as reflective and dielectric layers. The holography printed on the coatings does not disappear if other materials such as adhesives, laminates and other coatings are applied to the surface reliefs.

The coatings of the present invention may comprise: (1) dielectric coatings; (2) color shifting pigments; (3) luminescent pigments; (4) magnetic pigments; (5) security inks; (6) fluorescent pigments; and/or (7) phosphorescent pigments. A coating preferably is chosen such that various surface reliefs may be selectively applied to the final substrate in one or more passes. The coating may contain color shifting properties, magnetic properties, dielectric properties, and other properties. Additionally, any of the above-identified pigments and coatings may be mixed with microspheres in order to make the pigments brighter.

The coatings described herein are adapted to receive embossed or cast surface reliefs including, but not limited to: (1) holograms; (2) optical variable devices; (3) gratings; (4) computer generated holograms; (5) ebeam generated structures; (6) dot matrix holograms; (7) dot matrix stereograms; (8) retroreflective structures (e.g., corner cubes); (9) nano structures; (10) icrostructures; (11) micro fluidic structures; (12) micro electronic circuits; (13) moire patterns; (14) radio frequency identification (RFID) antennas; (15) lenticular lenses; (16) lenses; (17) self cleaning structures; (18) moth-eye structures; and (19) combinations of these structures.

Referring to FIG. 1A-1C, the coatings of the present invention may contain various combinations of particulate matter. For example, the coating of FIG. 1A contains metallic particles such that the coating is reflective. Although this coating lacks high (or low) refractive index particles, it may be used in connection with surface reliefs. On the other hand, the coating of FIG. 113 contains high (or low) refractive index particles, but lacks metallic particles. Although this coating does not contain metallic particles, it is reflective enough in order to see surface reliefs disposed on one of its surfaces. The coating of FIG. 1C contains both metallic particles and high (or low) refractive index particles. This coating will produce very bright surface reliefs. In addition, depending on the density of the metallic particles, the coating may be solid, transparent or semi-transparent.

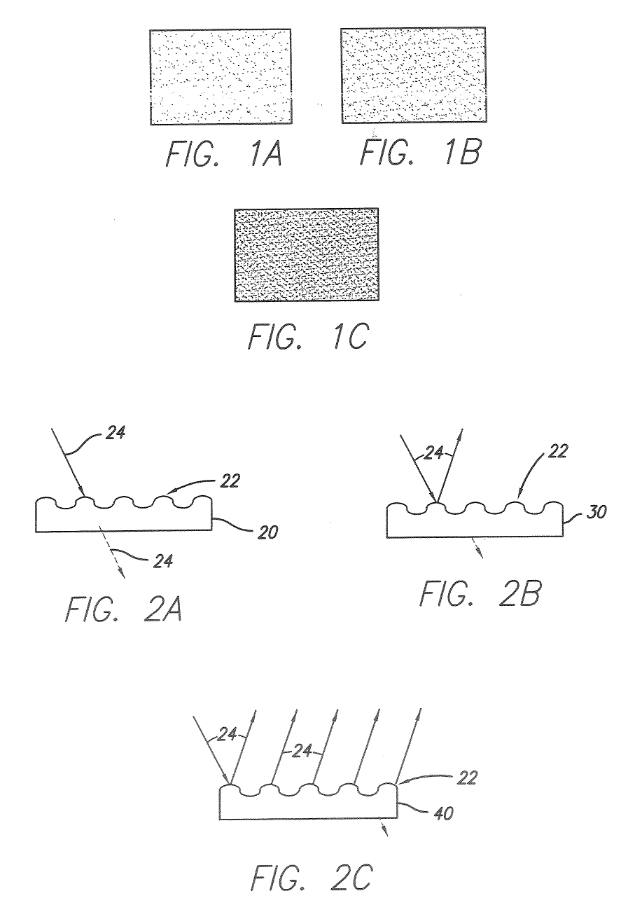

FIG. 2A depicts a transparent coating 20 with surface reliefs 22 applied thereto. In this case, surface reliefs 22 appear very dim since there is limited reflection of light 24. nstead, most of the light passes through transparent coating 20. FIG. 2B depicts an HRISR coating 30 having surface reliefs 22. Alternatively, coating 30 may comprise an LSISR coating. Since the coating has a high refractive index, a high percentage of light 24 is reflected, thereby making surface reliefs 22 more viewable. FIG. 2C depicts an HRISR and metallic coating 40 having surface reliefs 22. The metallic particles within coating 40 will help reflect an even higher percentage of light 24 such that the surface reliefs are highly visible to a human eye.

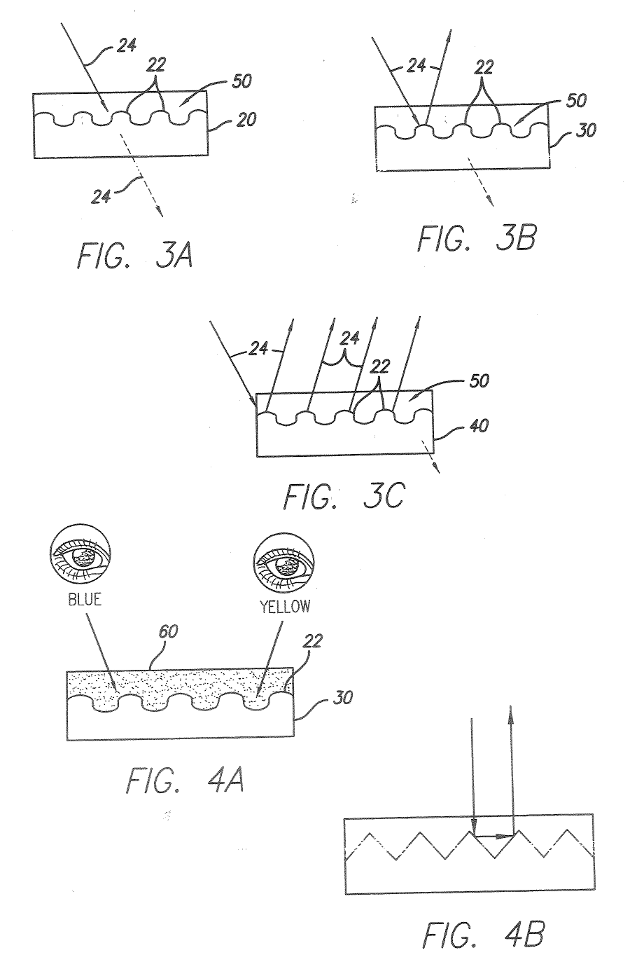

FIG. 3A depicts a transparent coating 20 with surface reliefs 22 applied thereto. When a second coating 50 is applied on top of the surface reliefs, they become invisible because virtually all of the light 24 passes through the transparent coating 20. By way of example, the second coating 50 may comprise various adhesives, inks, lacquers or laminates. FIG. 3C depicts an HRISR and metallic particle coating 40 having surface reliefs 22. After the second coating 50 is applied, surface reliefs 22 remain highly visible since coating 40 has a high refractive index and the metallic particles within coating 40 help reflect an even higher percentage of light 24.

FIG. 3B depicts all exemplary HRISR coating 30 of the invention having surface reliefs 22. According to other embodiments, the coating 30 may comprise an LRISR coating. After the second coating 50 is applied on top of the surface reliefs 22 of FIG. 3B, the surface reliefs remain visible since the coating 30 has a high refractive index compared to the second coating 50. The refractive index (or index of refraction) of a material is the factor by which the phase velocity of electromagnetic radiation is slowed in that material, relative to its velocity in a vacuum. Refractive index is defined as the relative speed at which light moves through a material with respect to its speed in a vacuum. By convention, the refractive index of a vacuum is defined as having a value of 1.0. The index of refraction, N (or n), of other transparent materials is defined through the equation: N=c/V, where c is the speed of light, and V is the velocity of light in that material. For practical purposes, the refractive index of light through air (1.0003) can be used to calculate refractive indices of unknown materials. The high refractive index coatings of the invention preferably have a refractive index of at least approximately 1.65, most preferably greater than about 2.0. In FIG. 3B, the first coating 30 remains visible after the second coating is applied because the first coating 30 comprises an HRISR coating which has a substantially higher refractive index than that of the second coating 50. A LRISR coating may be suitable provided that the refractive indices of the first and second coatings 30, 50 are sufficiently different such that the surface reliefs 22 remain highly visible after the second coating 50 is applied.

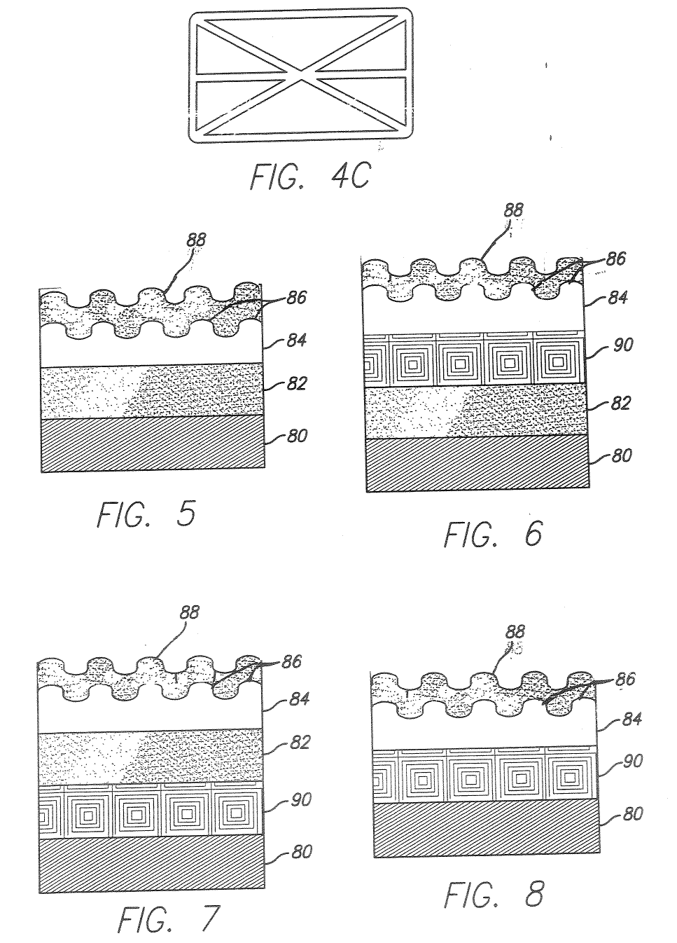

Referring to FIG. 4A, HRISR coating 30 having surface reliefs 22 is coated with a second coating 60 containing dielectric particles such that different hues are viewable at different viewing angles. Alternatively, coating 30 may comprise an LSISR coating. In addition, the surface relief effects are viewable at the same time. FIG. 4B depicts an HRISR and metallic particle coating 40 having a retroreflective surface reliefs 62 such that most light 24 is reflected back in substantially the opposite direction as it approached the surface reliefs. In the illustrated embodiment, retroreflective surface reliefs 62 is a corner cube structure. FIG. 4C depicts an RFID antenna 70 comprising an HRISR or LRISR coating with metallic particles such that the resultant structure comprises a holographic antenna. Alternatively, RFID antenna 70 may comprise and HRISR coating on top of a metallic coating such as a hot-stamping metallic foil, cold-stamping metallic foil or metallic ink.

FIGS. 5-12 depict various surface relief structures capable of being produced by applying the principles of the present invention, wherein similar elements have been numbered accordingly. Referring to FIG. 5, a substrate 80 is selectively coated with a metallic coating 82 such as a hot-stamping metallized foil, a cold-stamping metallized foil, metallic inks or metallic lacquers. In addition, a coating 84 having embossed surface reliefs 86 is applied on top of metallic coating 82, and then high refractive coating 88 such as a protective or printed layer may (or may not) be applied on top of coating 84. In particular, if coating 84 is an HRISR or LRISR coating, then there is no need to apply a special high refractive coating (coating 88) because such HRISR and LRISR coatings intrinsically contain the refractive index properties that are necessary to keep the holography viewable despite any printing on top of the coating 84. On the other hand, if the coating 84 does not comprise an HRISR or LRISR coating, then the high refractive coating 88 preferably is applied on top of coating 84. In this case, coating 88 preferably follows the topography of the surface reliefs 86 such that the thickness of coating 88 is substantially uniform In contrast, if the coating 88 were substantially flat, the holography would lose its visibility since the surface reliefs would be eliminated. Byway of example, the thickness of the coating 88 may be approximately 50 nm. The coating 88 may comprise a protective or printed layer such as an ink, lacquer, adhesive or laminate.

Referring to FIG. 6, substrate 80 is selectively coated with a metallic coating 82 such as a hot-stamping metallized foil, a cold-stamping metallized foil, metallic inks or metallic lacquers. Then, a printed layer 90 is applied on top of metallic coating 82, and coating 84 having embossed surface reliefs 86 is applied on top of printed layer 90. A high refractive coating 88 such as a protective or printed layer may (or may not) be applied on top of coating 84. More particularly, if coating 84 is an HRISR or LRISR coating, then it is unnecessary to have a special high refractive coating (coating 88) because HRISR and LRISR coatings include the refractive index properties that are necessary to keep the holography viewable despite any printing on top of the coating 84. Otherwise, if the coating 84 does not comprise an HRISR or LRISR coating, then the high refractive coating 88 preferably is applied on top of coating 84. The coating 88 preferably follows the topography of the surface reliefs 86, thus preserving the visibility of the holography.

Referring to FIG. 7, printed layer 90 is applied directly on top of substrate 80, and then metallic coating 82 is applied on top of printed layer 90. A coating 84 having surface reliefs 86 is applied on top of metallic coating 82, and then coating 88 such as a protective or printed layer may or may not be applied on top of the coating 84. Similar to the embodiments of FIGS. 5 and 6, if coating 84 is an HRISR or LRISR coating, then it is not necessary to apply a special high refractive coating (coating 88) because HRISR and LRISR coatings inherently include the refractive index properties that are necessary to keep the surface reliefs 86 viewable despite any printing on top of the coating 84. Contrariwise, if the coating 84 does not comprise an HRISR or LRISR coating, then the high refractive coating 88 preferably is applied on top of coating 84. The coating 88 preferably follows the topography of the surface reliefs 86 such that the surface reliefs 86 remain visible.

Referring to FIG. 8, printed layer 90 is again applied directly on top of substrate 80, however this embodiment does not feature a metallic coating. Instead, coating 84 is applied directly on top of printed layer 90 and coating 88 (e.g., a protective or printed layer) may or may not be applied on top of coating 84. In particular, if coating 84 is an HRISR or LRISR coating, then there is no need to apply a special high refractive coating (coating 88) because such HRISR and LRISR coatings already contain the refractive index properties that are needed to keep the holography viewable despite any printing on top of the coating 84. If the coating 84 does not comprise an HRISR or LRISR coating, then the high refractive coating 88 preferably is applied on top of coating 84. The coating 88 preferably follows the topography of the surface reliefs 86 such that the thickness of coating 88 is substantially uniforn. For example, the thickness of the coating 88 may be approximately 50 nm. The resultant holographic structure will appear semi-transparent such that the holography and printing are visible.

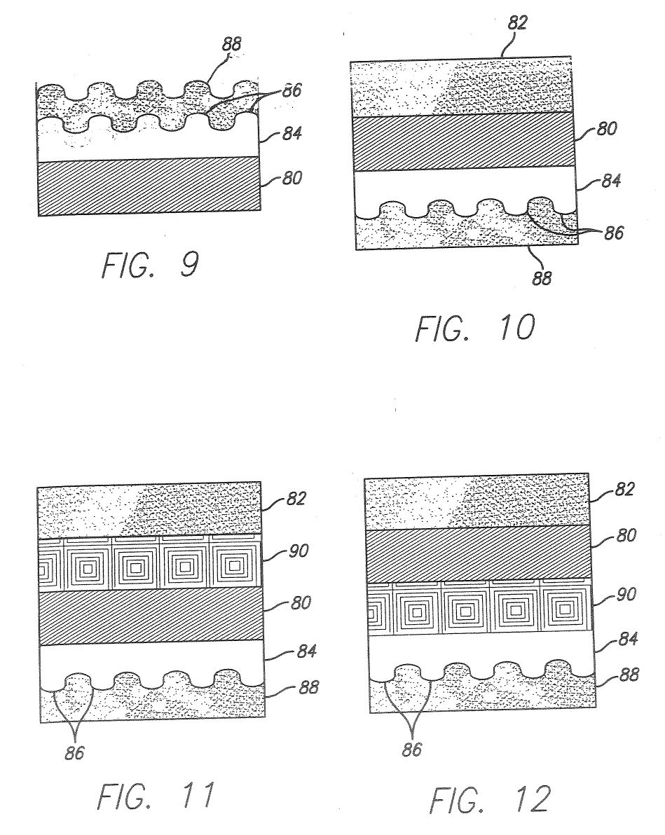

Referring to FIG. 9, coating 84 having surface reliefs 86 is applied directly on top of the substrate 80, and then coating 88 may or may not be applied over the surface reliefs. Similar to the embodiments of FIGS. 5-8, if coating 84 is an HRISR or LRISR coating, then there is no need to apply a special high refractive coating (coating 88) because such HRISR and LRISR coatings intrinsically contain the refractive index properties that are necessary to keep the surface reliefs 86 viewable despite any printing on top of the coating 84. However, if the coating 84 does not comprise an HRISR or LRISR coating, then the high refractive coating 88 preferably is applied on top of coating 84. In this case, the coating 88 preferably follows the topography of the surface reliefs 86 to preserve the visibility of the holography. The embodiment of FIG. 9 is a basic see-through hologram without a printed layer and a metallic layer. Referring to FIG. 10, coating 84 is reversed printed onto one side of substrate 80, whereas metallic coating 82 is applied to the opposite side of the substrate. Coating 88 (e.g., a protective layer such as an ink, lacquer, adhesive and/or laminate) is preferably applied on top of coating 84 only if coating 84 does not comprise an HRISR or LRISR coating 84.

Referring to FIG. 11, coating 84 is reversed printed onto one side of substrate 80, whereas printed layer 90 and metallic coating 82 are applied to the opposite side of the substrate. The coating 84 includes surface reliefs 86. Again, coating 88 (e.g., a protective ink, lacquer, adhesive or laminate) is preferably applied on top of coating 84 only if coating 84 does not comprise an HRISR or LRISR coating. Referring to FIG. 12, metallic coating 82 is applied to one side of substrate 80, whereas printed layer 90 is applied to the opposite side of the substrate. Coating 84 is then applied on top of the printed layer and coating 88 is preferably applied on top of coating 84 only if coating 84 does not comprise an HRISR or LRISR coating.

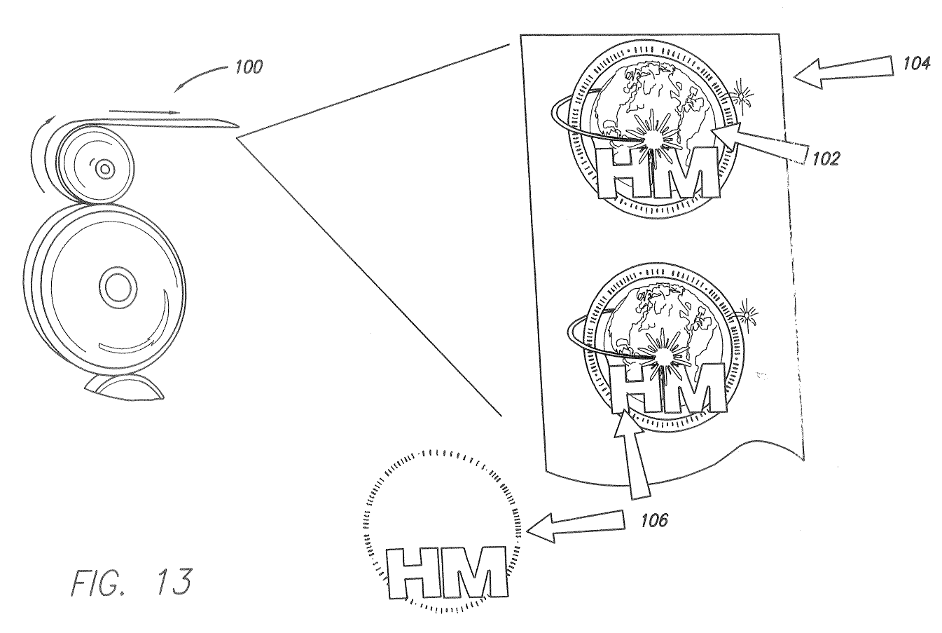

Referring to FIG. 13, conventional printing equipment 100 is used to print conventional ink-based images 102 onto a substrate 104. In accordance with the principles of the present invention, conventional printing equipment 100 is also used to print surface reliefs 106 onto substrate 104. Surface reliefs 106 can be printed on many different types of substrates, including, but not limited to: (1) plastic film; (2) paper; (3) synthetic paper; (4) boards; (5) aluminum foil; and (6) metallic sheets. Depending upon the type of substrate and coatings employed, surface reliefs 106 may be reflective, partially reflective or non-reflective. Additionally, the surface reliefs may be cast or cured with any type of Uv/EB substances, such as: (1) metallic ink; (2) transparent ink; (3) dielectric ink and/or lacquer; (4) pearlescent ink and/or lacquer; (5) thermochromic ink and/or lacquer; (6) conductive ink and/or lacquer; (7) ink made with holographic powder; (8) sliver inks; and (9) other types of W/EB-based substances for creating visual effects and security applications.

According to the invention, any of the above-identified UV/EB surface reliefs may be coated with a HRISR or LRISR coating to create a wide range of structures for labeling, packaging and security applications. By way of example, the coatings of the present invention may be used for printing: (1) currency; (2) security labels; (3) security documents; (4) travel checks; (5) driver licenses; (6) passports; (7) visas; (8) government documents; (9) tags; (10) packaging; and (11) many other labeling, packaging and security applications. The HRISR, LRISR and metallic coatings described herein may comprise high refractive index solvent based, water based, UV/EB inks and/or lacquers, metallic inks, conductive inks, silver inks and other coatings. Transparent curable ink may be applied on top of, or below, an HRISR or LRISR coating. The use of high or low refractive index transparent inks and lacquers (or metallic inks, etc.) prevents the resulting structure from becoming invisible when overprinted or overlaminated.

Many nano-, micro-, and macro-structures include surface reliefs that are reflective. iolograms are one example of reflective surface reliefs that typically require expensive metallizing equipment that is difficult to integrate with conventional printing. In addition, the manufacturing rate of reflective surface reliefs is traditionally extremely slow. According to an aspect of the invent on, a radiation curable coating that incorporates reflective particles may be applied to nano-, micro- and macro-structures in a single pass rather than two separate operations. A suitable radiation curable coating is a UV/EB ink or lacquer comprising: (1) metallic particles or flakes that become aligned substantially parallel to the substrate upon curing; and (2) a high or low refractive index coating mixed with the particles to brighten the nano-, micro-, and macro-structures. Since the radiation curable coating incorporates reflective particles that provide high refractive qualities, the resultant structures will reflect light and feature a metallic appearance.

According to the invention, metallic high or low refractive inks, lacquers, and other metallic coatings may be employed in the UV/EB curing applications described herein, in order to make the resulting structures reflective. Particularly, the metallic coating is cured while the substrate is wrapped against a surface relief tool, thereby increasing the speed and efficiency of the curing process. when using an electron beam curing process, the composition of the substrate will not affect the ability of the electrons to pass through the substrate to cure the metallic coating. The surface relief tool includes a surface relief that is substantially leveled such that there are no raised areas. The surface relief tool preferably includes localized surface reliefs on its area that may be identical to each other or different from each other.

According to some embodiments of the invention, the surface relief tool is attached to a chilled drum. The surface relief tool may comprise a nickel sleeve, a nickel plate, an etched metallic drum, a clear plastic film or a clear plastic plate. The HRISR or LRISR coating will conform to the surface relief on the embossing tool, thereby making a substantially exact copy of the surface relief features at high speed. Therefore, it is not necessary to emboss or cast the hologram at a first station and then apply the reflective or refractive coating at a second station. Both the embossing/casting step and the application of the coating step may be accomplished in one pass at a single station. According to other embodiments, the embossing and coating steps may be performed at separate stations.

According to another aspect of the invention, a chilling station is used to help cure the UV/EB metallic coating against the surface relief tool in a single curing step. The resulting decrease in curing temperature prevents substrate and surface relief distortions that are common when using prior art systems. Particularly, temperatures in the process rollers may be controlled to permit proper curing of surface relief with minimal distortion of the surface relief and the substrate to which the surface relief is attached. According to some embodiments of the invention, the thickness of the metallic coating may be varied along a continuum from very thin to very thick, depending upon the desired effect of the end product. The variable-thickness feature permits the creation of see-through holograms for packaging and security applications. According to other embodiments of the invention, the metallic coating may comprise a thin coating that substantially conforms to the shape of the surface reliefs.

According to an additional aspect of the invention, surface relief technology is provided that is compatible with reverse printing techniques that are widely used in the printing industry. One advantage of reverse printing is that the ink is protected because it never exposed. Electron beam curable equipment for reverse printing has come down in price considerably in recent years, such that it is economically feasible to install this technology on printing equipment for printing continuous forms, flexible packaging materials, rigid packaging materials, labels, and other printed products.

Due to advances in gearless press technology, it is possible to have substantially perfect registration among multiple print stations without the use of obsolete registration systems such as registration compensators. The coatings of the invention may be applied to an article or substrate using conventional gearless printing equipment including, but not limited to: (1) flexographic equipment; (2) rotogravure equipment; (3) offset equipment; (4) continuous form equipment; (5) digital printing equipment; (6) silkscreen equipment; (7) lithographic equipment; (8) letterpress equipment; and (9) ink jet printing.

The preferred printing machine for printing surface reliefs in accordance with the principles of the invention comprises a gearless machine that ensures substantially perfect registration between printing stations and the curing tool station. Each roller in the printing machine preferably is controlled by a se vomotor that is operated using a programmable logic controller, such that each roller is substantially perfectly synchronized and in register with the other rollers. With a gearless machine, it is possible to have different printing lengths without changing the diameters of the cylinders. Although the preferred printing equipment of the present invention is gearless, it should be evident to one of ordinary skill in the art that the invention maybe practiced using gear presses without departing from the scope of the invention.

According to an additional aspect of the invention, nano-, micro-, and macro-structures are capable of being printed using conventional printing methods, thus enabling printing at high speeds, at required widths, and in register with any conventional printing on the document or label being printed. Such structures include, but are not limited to: (1) electron beam generated holograms; (2) dot matrix holograms; (3) computer generated holograms; (4) optically variable devices (OVDs); (5) diffractive optical variable devices (DOVDs); (6) lenses; (7) lenticular lenses; (8) non-reflective structures; (9) light management structures; (10) deep structures (e.g., structures that diffract only 15 one wavelength at a very wide viewing angle, such as found in some butterflies and other insects); (11) radio frequency identification (RFID) antennas; (12) embossable computer chips; (13) retroreflective structures; (14) metallic-looking structures; (15) wood textures; (16) leather textures; and (17) textile textures.

According to the invention, flexo graphic printing equipment may be employed to apply a curable coating to a suitable substrate. Alternatively, rotogravure equipment, offset equipment, continuous form equipment, digital printing equipment, letterpress equipment, ink jet equipment and other systems may be employed to apply the curable coating. Additionally, metallic or non-metallic high-diffractive index inks or lacquers are employed, for example instead of vacuum deposited aluminum.

Referring to FTG. 14, an exemplary system 200 for printing surface reliefs 202 on substrate 204 using conventional printing equipment will now be described. The system 200 comprises anilox roller 212, flexographic tool 214, surface relief tool 216, curing tool 218 and printing rollers 220. Flexographic tool 214 preferably comprises a flexographic printing sleeve or plate attached to a master roller that is chilled to a predetermined temperature. The flexographic tool facilitates the transfer of complex shapes (raised sections 228) onto surface relief tool 216. Raised sections 228 substantially comprise an exact copy and location of the sections on surface relief tool 216 where the surface reliefs are placed. For example, flexographic tool 214 may include raised areas 228 provided with a metallic HRISR or LRISR coating for transferring the topography of raised areas 228 onto precise sections of surface relief tool 216. The creation of raised sections on the surface relief tool itself would be far more difficult and expensive.

The system 200 further comprises a temperature-controlled tray 230 for the high or low refractive index material, metallic inks, conductive inks, silver inks, or other materials that form the coating. Temperature-controlled tray 230 is designed to feed anilox roller 212, which carries the high or low refractive index material onto flexographic tool 214. The raised features of flexographic tool 214 pick up the high or low refractive index material from anilox roller 212. A doctor blade 232 may be provided for wiping excess ink away from raised areas 228 of flexographic tool 214. One advantage of using an HRISR or LRISR coating is that such a coating enhances the holography since it inherently reflects more light than a conventional thin clear coating, thereby increasing the brightness and definition of the resultant holographic image.

The anilox roller 212 and associated tray are maintained at the predetermined temperature in order to induce the metallic particles within the high or low refractive index material to align substantially parallel to the major surface of the substrate. Anilox roller 212 may be heated or chilled depending on the printing configuration needed for a specific substrate. For example, the anilox roller 212 may be heated to help the metallic particles in the metallic coating accommodate before curing. In addition, the master roller to which the flexographic sleeve is attached may be heated in order to preserve a selected temperature before curing.

In operation, the raised areas 228 on the flexographic tool 214 deposit the HRISR or LRISR coating (or metallic ink, silver ink, conductive ink, etc.) onto the surface of surface relief tool 216 in substantially perfect register to the surface reliefs in surface relief tool 216. The substrate is fed between surface relief tool 216 and printing rollers 220 such that substrate 204 is pressed against surface relief tool 216. Thus, the HRISR or LRISR coating is pressed against the surface relief tool 216 as it is being cured in a single pass by curing tool 218. According to an implementation of the invention, the curing tool 218 provides electromagnetic radiation, such as ultra-violet radiation treated with a beam of high energy electrons (UV/EB), for cuing the coating in a single pass. As would be understood by those of ordinary skill in the art, other types of electromagnetic radiation may be used for curing the coating without departing from the scope of the present invention.

The surface relief tool 216 comprises localized areas having surface relief features that correspond with a very high degree of precision to the location of the areas of refractive index material (or metallic ink, silver ink, conductive ink, etc.) on the flexographic tool 214. The surface relief tool 216 may comprise a nickel surface relief sleeve, a nickel plate and/or a clear embossed plastic plate that is attached to a chilled casting roller in order to maintain the substrate at a predeter ined temperature, which is selected based on the type of substrate being employed as well as the process speed. If the surface relief tool is a sleeve, the chilled casting roller is slid into the sleeve, whereas if the surface relief tool is a plate, the chilled casting roller is clamped to the plate. The use of a chilled casting roller ensures that the surface relief tool imparts a substantially exact copy of the surface relief onto the substrate, at room temperature with no major distortions to either the substrate or the surface reliefs. The curing tool 218 cures the coating in a single pass as the substrate is pressed against the surface relief tool 216.

According to some embodiments of the invention, the printing on the substrate overlaps the surface relief in substantially perfect register. According to other embodiments of the invention, the printing on the substrate does not overlap the surface relief pattern. According to further embodiments, the printing and/or surface relief may be provided as a continuous wallpaper pattern with no registration requirement. Additionally, the printing and/or surface relief may be printed on either major surface of the substrate.

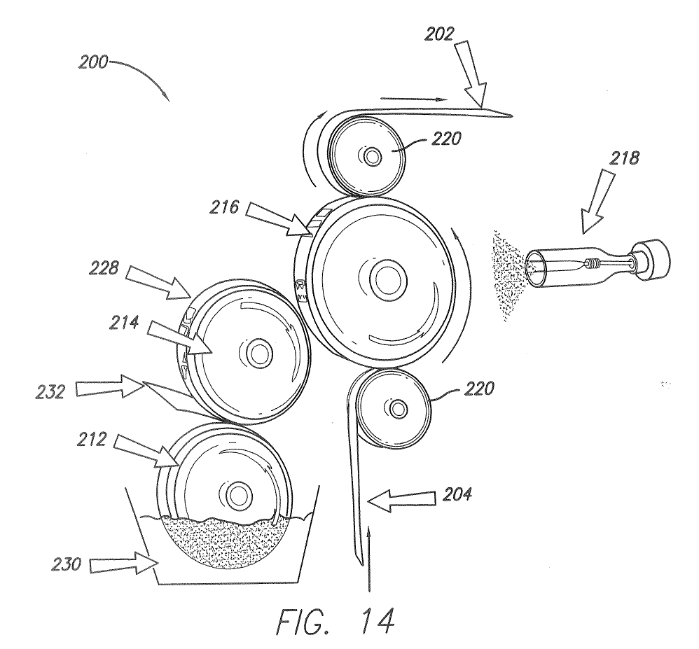

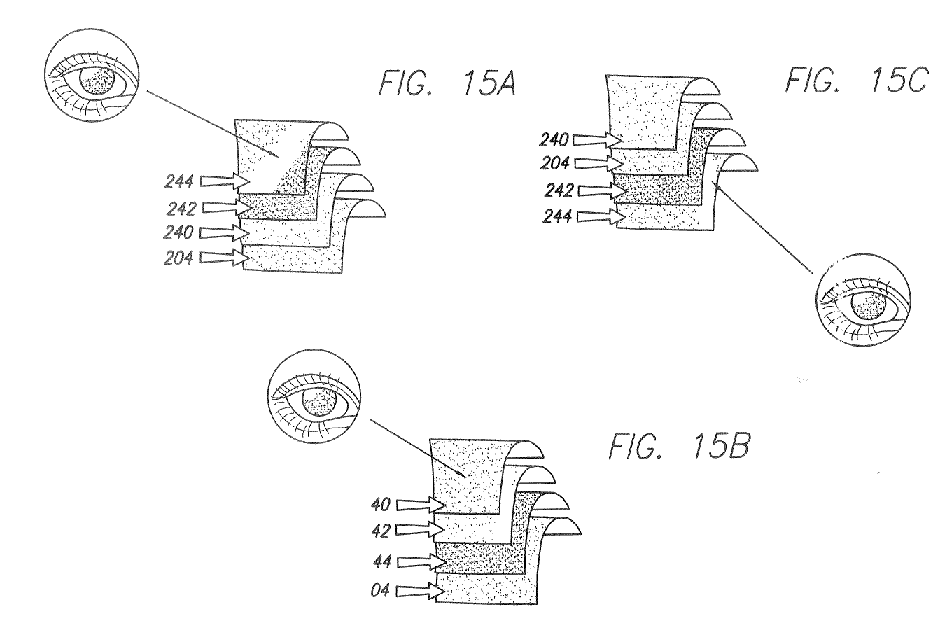

With further reference to FIG. 14, the HRISR or LRISR coating within temperature-controlled tray 230 may include metal particles for producing a metallic coating. Aluminum is one suitable material for the metal particles. When curing the metallic coating, the metal particles are aligned substantially parallel to the substrate such that the resultant product is reflective. In order to correctly align the particles, the metallic coating is heated to a predetermined temperature that allows the particles to settle substantially parallel to the substrate, such that the particles follow the contour of the surface relief. As discussed hereinabove, the metallic coating is cured using curing tool 218 while the substrate 204 is being pressed against surface relief tool 216 by printing rollers 220. Once cured, the metallic coating is adhered to substrate 204, which is separated from surface relief tool 216. The substrate 204 will then exhibit surface reliefs that are a substantially exact copy of the surface reliefs on surface relief tool 216.

Many prior art holography systems rely on applying a metallic hot-stamping foil, hard embossing using both heat and pressure, or hybrid embossing. By contrast, exemplary system 200 for printing surface reliefs 202 on substrate 204 using conventional printing equipment does not require any external heat or pressure source, and there is no consequential distortion of the substrate or visible loss of resolution of the original image. Additionally, the system 200 of the invention is capable of producing brighter images than conventional systems with minimal wear and tear of the surface relief tool.

Referring to FIG. 1 5A, according to an embodiment of the invention, a metallic base layer 240 (e.g., a metallic coating, hot-stamp metallic foil or cold-stamp metallic foil) is initially applied to substrate 204. Then, metallic base layer 240 is coated with a high refractive index material layer 242 having surface reliefs 244. After curing, the resultant surface reliefs will have an image featuring excellent brightness and definition. Metallic base layer 240 may be used in conjunction with a transparent HRISR or LRISR coating. Particularly, metallic base layer 240 is applied to the substrate, and then the transparent HRISR or LRISR coating with the holographic structure is cured on top of the metallic coating. The transparent HRISR or LRISR coating is conducive to both printing and reverse printing the holography and inks. Referring to FIG. 15B, according to an alternative embodiment of the invention, high refractive index material layer 242 having surface reliefs 244 is initially cured onto the substrate, and then metallic base layer 240 is applied on top of high refractive index material layer 242. The resultant surface reliefs will be visible with excellent brightness and definition.

Similar to the embodiment of FIG. 15A, a transparent HRISR or LRISR coating may be employed as layer 242. The resultant image is visible in reverse printing with excellent brightness and sharpness characteristics. Referring to FIG. 15C, according to another alternative embodiment of the invention, metallic base layer 240 is applied to one major surface of substrate 204. The opposite major surface of substrate 204 is coated with a high refractive index material layer 242 having surface reliefs 244. The metallic ink is cured in a similar manner as the surface reliefs are cured. More particularly, the metallic ink and surface reliefs are cured by wrapping the substrate against the embossing tool, and then curing the metallic ink and surface reliefs through the substrate.

Another method for producing reflective surface reliefs involves: (1) applying metallic ink and or lacquer that it is cured against a mirror finish chilled roller at a first station; and (2) applying a high reflective index ink and/or lacquer that is cured on top of the mirror finish at a second station. Particularly, since the roller has a mirror finish, the metallic ink will become a mirror finish as well. Any type of texture in the macro relief may be imparted onto the mirror finish flexographic roller, and any type of texture may be imparted onto the metallic UV/EB inks (e.g., brushed films, polished aluminum surfaces and engraved stamping dies). The imparting of texture may be used in the production of labels, packaging, shrinkable films, greeting cards, and other products. The application of texture to the mirror finish may require the use of an additional curing tool.

Alternatively hot-stamping metallized foils, cold-stamping metallized foils and metallic inks may be used as the mirror base at the first station, and then the high reflective index ink and/or lacquer is cast and applied onto the already placed metallic finish. The hot-stamping is applied at the first station with a hot-stamping rotary attachment using heat and pressure, whereas the cold-stamping is accomplished by first applying a cold stamping adhesive and laminating the foil to it. In either case, the foils are applied to the surface of the substrate in the exact shape and location that the holography will have on top of them. This method for producing reflective surface reliefs may also be accomplished using a one-step process at a single station.

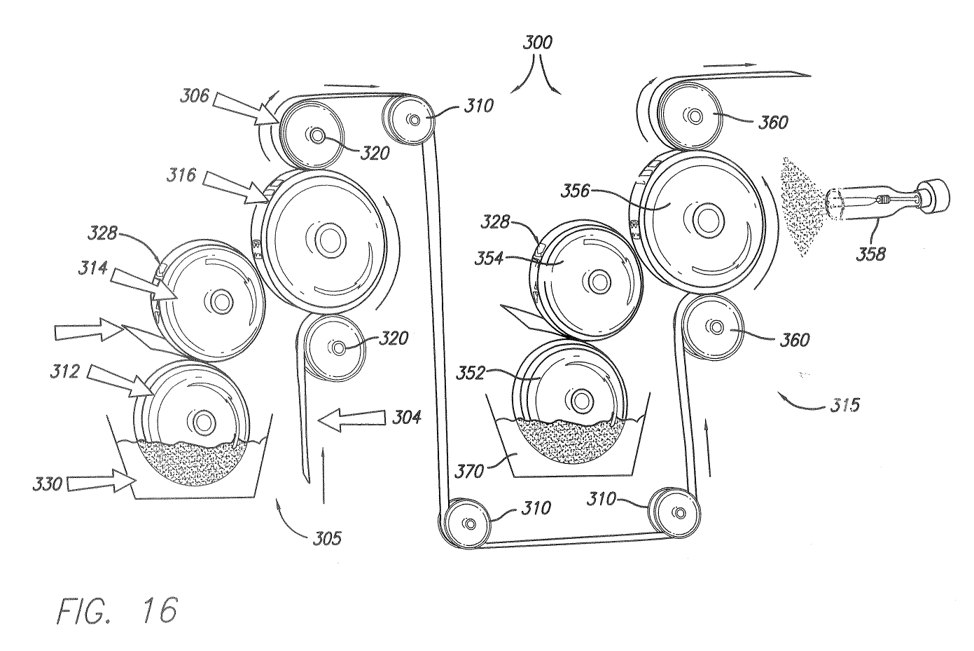

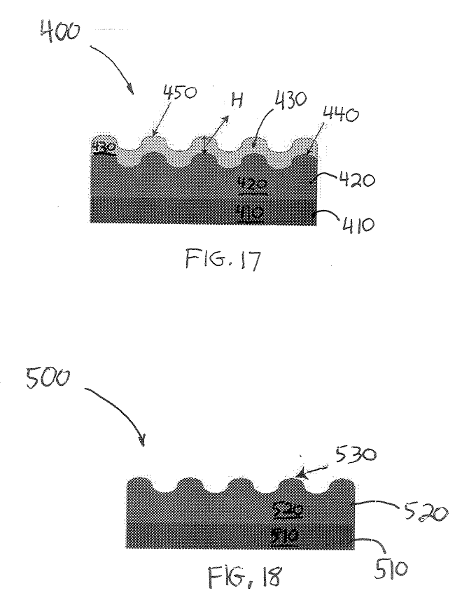

Referring to FIG. 16, a system 300 of printing mirrored surface reliefs on a substrate 304 using conventional printing equipment will now be described. The system 300 comprises a first printing station 305 for applying a mirrored finish 306 to substrate 304, and a second printing station 315 for curing surface reliefs 328 on top of mirrored finish 306. The first and second printing stations are interconnected by a web including substrate 304 and rollers 310. First printing station 305 comprises anilox roller 312, flexographic tool 314, temperature controlled mirror finish roller 316, printing rollers 320 and temperature-controlled tray 330, whereas second printing station 315 comprises anilox roller 352, flexographic tool 354, surface relief tool 356, curing tool 358, printing rollers 360 and temperature-controlled tray 370.

The flexographic tools 314, 354 preferably each comprise a flexographic printing sleeve or plate attached to a master roller that is temperature controlled to a predetermined temperature. Flexographic tool 354 facilitates the transfer of complex shapes (raised sections 328) onto surface relief tool 356. The temperature-controlled tray 330 is designed to feed anilox roller 312, which carries metallic ink that will be cured against mirror finish roller 316. Temperature controlled tray 370 is designed to feed anilox roller 352, which carries a high refractive index material onto flexographic tools 314, 354, respectfully. n operation, the raised areas 328 on the flexographic tool 354 deposit the HRISR or LRISR coating onto the surface of surface relief tool 356 in substantially perfect register to the surface reliefs in surface relief tool 356. The substrate is fed between surface relief tool 356 and printing rollers 360 such that the HRISR or LRISR coating is pressed against surface relief tool 356 as it is being cured by curing tool 358.

The system of FIG. 16 may be used for “pad printing” or tampography, wherein a metallic base is applied at the first station, and a surface reliefs with a refractive index coating is applied at the second station. The use of pad printing or tampography allows the surface reliefs to be imparted onto objects having intricate shapes. Otherwise, the surface reliefs may only be imparted on substantially flat substrates.

Shrinkable films tend to be extremely sensitive to heat, tension, and pressure. A further application of the principles of the present invention concerns the production of shrinkable films having print and holography that are in register, without causing the films to shrink and/or distort. In some prior art systems, the holography is transferred to the shrinkable film using a transfer process. By contrast, in accordance with the principles of the present invention, the film is printed using conventional printing equipment. Specifically, at a first printing station, a metallic coating is applied to a substrate, and at a second printing station, the holographic structure is cured on top of the metallic surface using a high refractive index lacquer. Alternatively, other metallic or non-metallic HRISR and LRISR coatings may be employed instead of the high refractive index lacquer.

FIGS. 17-20 depict cross-sectional views of various exemplary articles produced using the principles of the present invention. The articles may comprise currency documents, continuous labels, non-continuous labels, lottery tickets, pack structures and containers. In addition, these articles may include conventional printing comprising a suitable ink or lacquer, such as any of the HRISR and LRISR coatings described hereinabove. Moreover, the surface reliefs and lenticular printing may be selectively mixed to create the desirable effects. It is noted that the articles may comprise any number of different structures, including without limitation: (1) tattoos; (2) shrink wrap labels; (3) flexible packaging; (4) rigid packaging; (5) credit cards; (6) licenses; (7) security documents such as continuous forms; (8) retroreflective structures; (9) non-reflective structures; (10) intelligent substrates such as self cleaning substrates; (11) radio frequency identification products; (12) plastic chips; (13) micro-analysis systems; (14) optical components; (15) medical applications; (16) polymer displays; (17) solar panels; (18) defense applications; and (19) radar invisibility applications.

Referring to FIG. 17, in accordance with the principles of the invention, an exemplary article 400 comprises (from bottom to top) a substrate 410, a UV or EB coating 420 applied on top of the substrate 410, a high or low refractive index lacquer or sol-gel 430 applied on top of coating 420, surface reliefs 440 created by the UV or EB coating 420, and surface reliefs 450 created by the high or low refractive index lacquer or sol-gel 430. The high or low refractive index lacquer or sol-gel 430 may be replaced with a metallic ink, a silver ink or a conductive ink without departing from the scope the invention. By way of example, the sol-gel 430 may be water-based, UV/EB, solvent-based, or silver reduction based. In the illustrated embodiment, an average height H of surface relief 450 is approximately 50 nm. The article 400 is formed using two distinct printing stations, for example using the system 300 of FIG. 16. As set forth hereinabove, the article 400 may comprise any number of different articles such as currency, labels, lottery tickets, packaging, credit cards, and any other articles described herein.

Referring to FIG. 18, another exemplary article 500 of the invention comprises, from bottom to top, a substrate 510, a high or low refractive index lacquer or sol-gel 520 applied directly on top of the substrate 510, and surface reliefs 530 created by the high or low refractive index lacquer or sol-gel 520. This embodiment comprises a basic hologram without a printed layer or a metallic layer. However, the surface reliefs remain visible due to the high or low refractive index lacquer or sol-gel 520, which is selected to have a refractive index that it is substantially different than the refractive index of the substrate 510. The article 500 is formed in a single pass using a single printing station, for example using the system 200 of FIG. 14.

Referring to FIG. 19, a further exemplary article 600 of the invention comprises (from bottom to top) a substrate 610, a UV or EB coating 620 applied on top of the substrate 610, a high or low refractive index coating or sol-gel 630 applied on top of coating 620, surface reliefs 640 created by the UV or EB coating 620, surface reliefs 650 created by the high or low refractive index lacquer or sol-gel 630, and a transparent coating 660 applied on top of surface reliefs 650. Since the coating 660 is transparent, the surface reliefs 640, 650 do not disappear after the coating 660 is applied. By way of example, the transparent coating 660 may comprise a transparent ink, adhesive or laminate, whereas the sol-gel 630 may be water-based, UV/EB, or solvent-based. The article 600 is formed using two distinct printing stations, for example using the system 300 of FIG. 16.

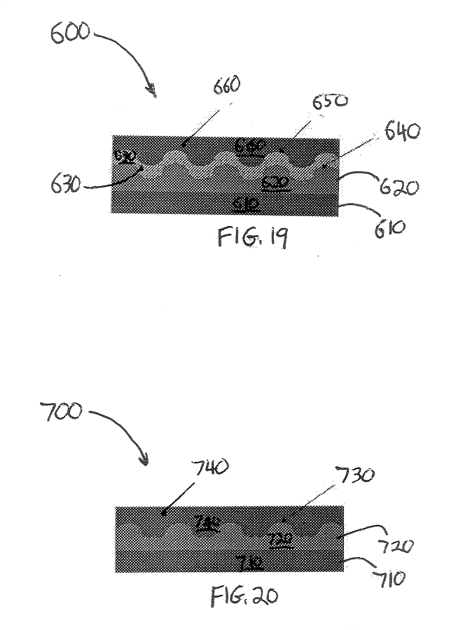

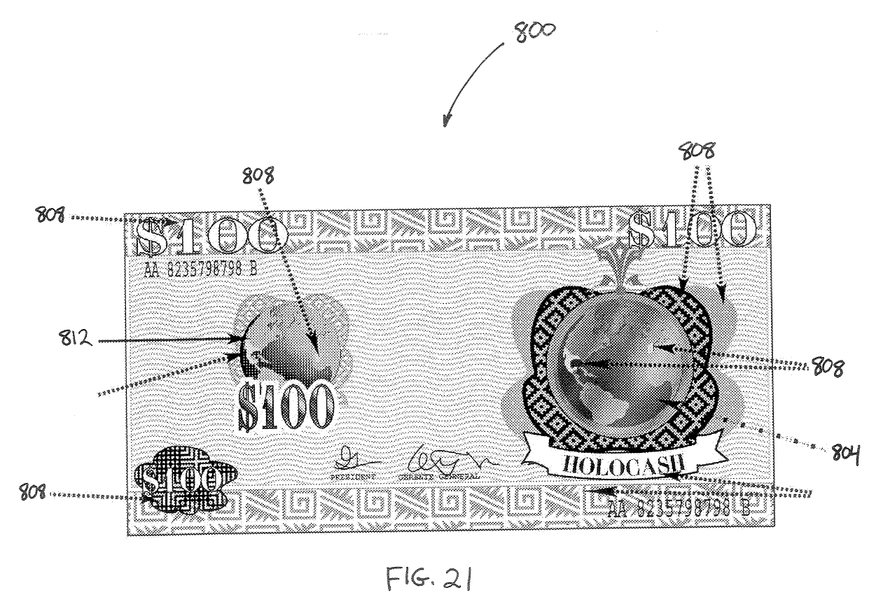

Referring to FIG. 20, an additional exemplary article 700 of the invention comprises, from bottom to top, a substrate 710, a high or low refractive index lacquer or sol-gel 720 applied directly on top of the substrate 710, surface reliefs 730 created by the high or low refractive index lacquer or sol1-gel 720, and a transparent coating 740 applied on top of the surface reliefs 730. Since the coating 740 is transparent, the surface reliefs 730 do not disappear after the coating 740 is applied. For example, the transparent coating 740 may comprise a transparent ink, adhesive or laminate. Article 700 features a hologram without a printed layer or a metallic layer, wherein the article 700 is formed in a single pass using a single printing station such as the system 200 of FIG. 14.

The surface reliefs of FIGS. 17-20 are preferably applied to the substrate at substantially the same speeds and widths of conventional printing, and in substantially perfect register to conventional printing. According to some embodiments, a high or low refractive index UV/EB, sol-gel curable coating may be used to cast or emboss the surface reliefs on top of the substrate. According to further embodiments, a high or low refractive index solvent based, water-based, UV/EB or sol-gel curable coating may be applied to coat previously cast or embossed surface reliefs.

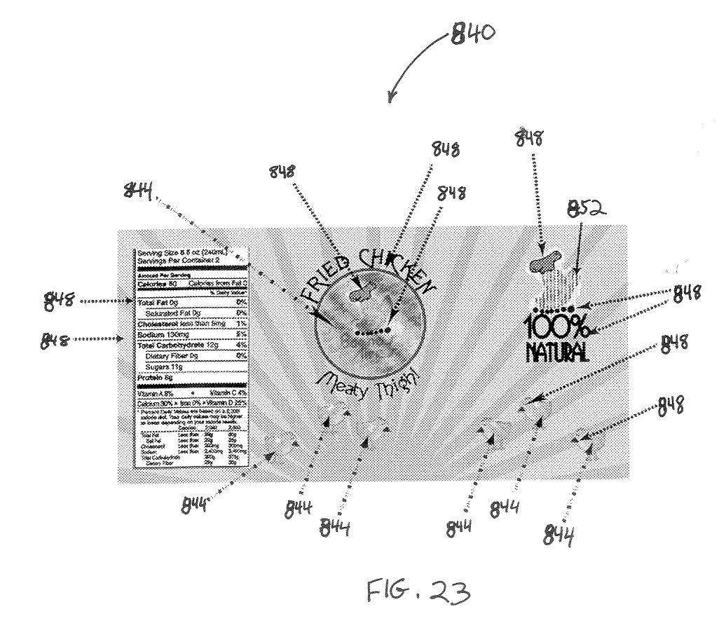

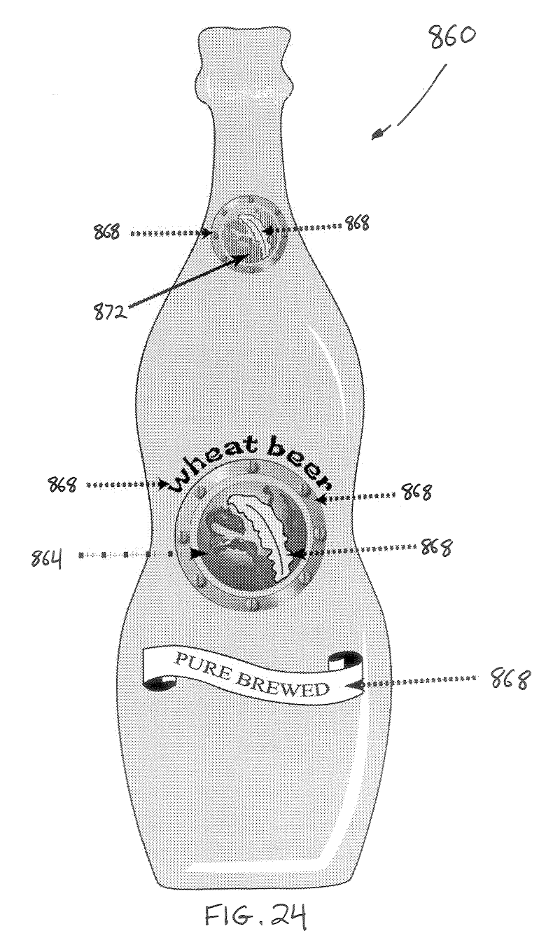

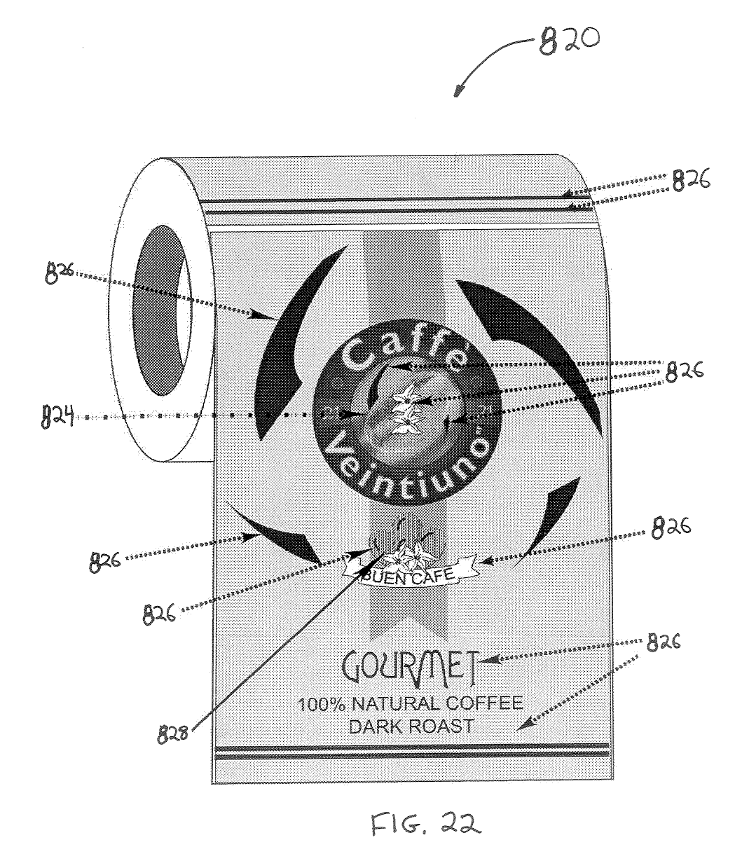

FIGS. 21-24 depict various exemplary articles produced using the principles of the present invention. Specifically, FIG. 21 illustrates a currency document 800 comprising surface relief 804, conventional printing 808 and online lenticular printing 812, while FIG. 22 depicts a continuous label 820 comprising surface relief 824, conventional printing 826 and online lenticular printing 828. Additionally, FIG. 23 depicts a label 840 comprising surface reliefs 844, conventional printing 848 and online lenticular printing 852, whereas FIG. 24 depicts a container 860 comprising surface relief structure 864, conventional printing 868 and online lenticular printing 872. In FIGS. 21-24, the conventional printing may comprise a suitable ink or lacquer, such as any of the HRISR and LRISR coatings described hereinabove. In addition, the surface relief structures and lenticular printing may be selectively mixed to create the desirable effects. The articles illustrated in FIGS. 21-24 are mere examples of the numerous articles that may be manufactured in accordance with the principles of the invention.

Thus, it is seen that substrates and articles having selective printed surface reliefs that are applied using conventional printing equipment are provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

What is claimed is:

1. An article, comprising:
a substrate;
a coating that is applied to the substrate; and
surface reliefs that are cast or embossed onto the high or low refractive index surface relief coating at substantially the same speeds and widths of conventional printing, and in substantially perfect register to conventional printing.

2. The article of claim 1, wherein the coating comprises a high or low refractive index surface relief coating.

3. The article of claim 1, wherein the coating comprises a water-based coating, a solvent-based coating, a U/EB based coating, a sol-gel based coating, a conductive coating, a silver reduction based coating or a metallic coating.

4. The article of claim 1, wherein the article is selected from the group consisting of: (1) a tattoo; (2) a shrink wrap label; (3) flexible packaging; (4) rigid packaging; (5) a credit card; (6) a license; (7) a security document; (8) a retroreflective structure; (9) a non-reflective structure; (10) a self cleaning substrate; (11) a radio frequency identification product; (12) a plastic chip; (13) a micro-analysis system; (14) an optical component; (15) a medical application; (16) a polymer display; (17) a solar panel; (18) a defense application; and (19) a radar invisibility application.

5. The article of claim 1, wherein the surface reliefs are selected from the group consisting of: holograrns; optical variable devices; gratings; computer generated holograms; ebeam generated structures; dot matrix holograms; dot matrix stereograms; retroreflective structures; nanostructures; microstructures; micro fluidic structures; micro electronic circuits; moire patterns; RFID antennas; lenticular lenses; lenses; self cleaning structures; moth-eye structures; and combinations of these structures.

6. The article of claim 1, wherein the coating is used to cast or emboss the surface reliefs on top of the substrate.

7. The article of claim 1, further comprising a protective coating applied on top of the surface reliefs.

8. The article of claim 7, wherein the protective coating follows a topography of the surface reliefs such that a thickness of the protective coating is substantially uniform.

9. An article, comprising:
a substrate;
a UV or EB coating applied on top of the substrate;
a high or low refractive index lacquer, sol-gel, metallic ink, silver ink or conductive ink applied on top of the coating;
surface reliefs created by the UV or EB coating; and
surface reliefs created by the high or low refractive index lacquer, sol-gel, metallic ink, silver ink or conductive ink.

10. The article of claim 9, wherein the high or low refractive index lacquer, sol-gel, metallic ink, silver ink or conductive ink is water-based, UV/EB, or solvent based.

11. The article of claim 9, wherein the surface reliefs are applied to the substrate at substantially the same speeds and widths of conventional printing, and in substantially perfect register to conventional printing.

12. The article of claim 9, wherein the high or low refractive index lacquer, sol-gel, metallic ink, silver ink or conductive ink is used to cast or emboss the surface reliefs on top of the substrate.

13. The article of claim 9, further comprising a protective coating applied on top of the surface reliefs.

14. The article of claim 13, wherein the protective coating follows a topography of the surface reliefs such that a thickness of the protective coating is substantially uniform.

15. The article of claim 9, wherein the article is selected from the group consisting of: (1) a tattoo; (2) a shrink wrap label; (3) flexible packaging; (4) rigid packaging; (5) a credit card; (6) a license; (7) a security document; (8) a retroreflective structure; (9) a non-reflective structure; (10) a self cleaning substrate; (11) a radio frequency identification product; (12) a plastic chip; (13) a micro-analysis system; (14) an optical component; (15) a medical application; (16) a polymer display; (17) a solar panel; (18) a defense application; and (19) a radar invisibility application.

16. An article, comprising:
a substrate;
a lacquer, sol-gel, metallic ink, silver ink or conductive ink applied on top of the substrate;
surface reliefs created by the high or low refractive index lacquer or sol-gel; and
a protective coating applied on top of the surface reliefs.

17. The article of claim 16, wherein the protective coating follows a topography of the surface reliefs such that a thickness of the protective coating is substantially uniform.

18. The article of claim 16, wherein the protective coating is selected such that it is high refractive.

19. The article of claim 16, wherein the protective coating comprises a transparent ink, adhesive or laminate.

20. The article of claim 16, wherein the article is selected from the group consisting of: (1) a tattoo; (2) a shrink wrap label; (3) flexible packaging; (4) rigid packaging; (5) a credit card; (6) a license; (7) a security document; (8) a retroreflective structure; (9) a non-reflective structure; (10) a self cleaning substrate; (11) a radio frequency identification product; (12) a plastic chip; (13) a micro-analysis system; (14) an optical component; (15) a medical application; (16) a polymer display; (17) a solar panel; (18) a defense application; and (19) a radar invisibility application.
